(19) United States
(12) Patent Application Publication
(10) Pub. No.: US 2016/0236534 A1
(43) Pub. Date: Aug. 18, 2016

(54) MOTOR VEHICLE HAVING AN AIR-CONDITIONING SYSTEM

(71) Applicant: WEIDPLAS GMBH, Rapperswil (CH)

(72) Inventors: Piero DAL VECCHIO, Ermenswil (CH); Stefan HARKE, Sinsheim (DE); Armin MULLER, Kaltbrunn (DE); Christian BOLSTERLI, Durnten (CH)

(73) Assignee: WEIDPLAS GmbH, Rapperswil (CH)

(21) Appl. No.: 15/029,142

(22) PCT Filed: Sep. 30, 2014
(86) PCT No.: PCT/EP2014/070948

§ 371 Date: Apr. 13, 2016

(30) Foreign Application Priority Data
Oct. 14, 2013 (CH) 01760/13

(51) Int. Cl. B60H 1/00; F25B 9/00; B60H 3/02; B60H 1/32

(52) U.S. Cl. CPC B60H 1/00028; B60H 1/3233; F25B 9/008; B60H 1/00564; B60H 3/02; B60H 1/00342; B60H 2001/00085; B60H 2001/00099; B60H 2001/00242

(57) ABSTRACT

The invention relates to a not vehicle (1), comprising a passenger compartment (2) and an engine compartment (26), wherein the passenger compartment (2) is separated from the engine compartment (26) by a firewall (25), and comprising an air-conditioning system (3) for heating and/or cool:flag the passenger compartment (2). The air-conditioning system comprises a compressor (6), an expansion valve (5), a first heat exchanger (4), and at least one second heat exchanger (7), which are fluidically connected to each other by means of a heat-transfer medium, and a first conducting structure (8) for conducting a first air flow (11) from an outer body opening (3) into the first heat exchanger (4), which first heat exchanger is suitable for providing energy exchange between the heat-transfer medium and the first air flow (11), wherein the first heat exchanger (4) is connected to the passenger compartment (2) in order to feed the first air flow (11) into the passenger compartment (2). According to the invention, a second conducting structure (12) for conducting a second air flow (13) is provided, which second conducting structure is suitable for conducting air from the passenger compartment (2) into the second heat exchanger (7), which second heat exchanger is suitable for providing energy exchange between the heat transfer medium and the second air flow (13).

The invention relates to a motor vehicle having a passenger inner space and an engine compartment, wherein the passenger inner space is separated from the engine compartment by a front wail, having an air-conditioning system which is for heating and/or cooling the passenger inner space and which comprises a compressor, an expansion valve, a first heat exchanger and at least one second heat exchanger, which are connected to each other in fluidic terms by means of a heat exchange medium, further comprising a first guiding structure in order to guide an air flow from an outer bodywork opening into the first heat exchanger which is suitable for constituting an energy exchange between the heat exchange medium and the air flow, wherein the first heat exchanger is connected to the passenger inner space in order to supply the first air flow to the passenger inner space.

### PRIOR ART

Motor vehicles having air-conditioning systems which are suitable for cooling a passenger inner space have been known to the person skilled in the art for some time. They are constructed as described in the above section. “Subject-matter”, wherein the first heat exchanger is constructed as a so-called evaporator in order to transmit cold, energy to the air flow which is supplied to the passenger inner space. It is known that such air-conditioning systems can he operated only with a high level, of energy expenditure.

A motor vehicle having an air-conditioning system which is suitable for heating and/or cooling the passenger inner space is set out in DE 198 066 54 A1. This air conditioning system comprises a heat exchange medium which is present in phases in the gaseous, liquid and supercritical state. A compressor conveys the heat exchange medium under high pressure via an expansion valve and a first heat exchanger which is suitable for constituting an energy exchange between the heat exchange medium and an air flow which is directed into the passenger inner space, toward a second heat exchanger. Typical pressures of the heat exchange medium are approximately from 3 to 70 bar for partially fluoridated heat exchange media and up to 150 bar for carbon dioxide. The air-conditioning system can be operated, by suitable selection and connection of the selected components of the air-conditioning system, both in heating mode as a so-called heat pump which is suitable for providing heat energy for the passenger inner space irrespective of the type and operating state of a propulsion unit of the motor vehicle, and in cooling mode as a refrigerating unit which is suitable for providing cold energy for the passenger inner space. Compressed carbon dioxide is proposed as a preferred heat exchange medium. However, such air-conditioning systems have a high energy requirement for the operation thereof irrespective of the selection of the heat exchange medium.

In order to improve the efficiency of the air-conditioning system, that is to say, the operating capacity under unfavorable environmental conditions, there must further often be provided in this air-conditioning system an inner heat exchanger which allows an internal energy exchange of the heat exchange medium at various locations of the air-conditioning system. Those inner heat exchangers are necessary in particular in the case of heat exchange media such as, for example, carbon dioxide, which have to be operated at least partially in a trans-critical manner. The thermodynamic effect of such an inner heat exchanger is set out in FIG. 4 of WO2008/003841 A1 in a log p/h chart which indicates that, by means of an inner heat exchanger, the trans-critical operation is possible in spite of the unfavorable environmental conditions, in particular at very high ambient temperatures, but requires a higher energy expenditure. In principle, this disadvantage applies both to the case that the passenger inner space is intended to be heated and to the case of a desired cooling of the passenger inner space.

In order to increase the energy efficiency of the motor vehicle, EP1316450 A1 proposes that there be introduced into the fluidic cycle of the heat exchange medium of the air-conditioning system, which is operated as a refrigerator unit, an additional heat exchanger which is suitable for re-evaporating condensation water which occurs at the first heat exchanger of the air-conditioning system being operated as an evaporator, and therefore for further cooling the heat exchange medium in this instance, the additional heat exchanger may be provided at various locations in the fluidic cycle of the heat exchange medium. There may also be provision for the condensation water occurring to be evaporated by means of ambient air flowing over at this additional heat exchanger. It is described that this embodiment of the air-conditioning system is effective at very high temperatures and at the same time with low relative air humidity levels of the ambient air.

A disadvantage in the air-conditioning system according to EP1316450 A1 is that the evaporation enthalpy of the condensation water can be used in principle at the additional heat exchanger only during cooling operation of the air-conditioning system but not when the environmental conditions require heating operation. Furthermore, the effectiveness of the air-conditioning system is limited to a few states of the ambient air with relative air humidity levels which are not too high and not too low. With high relative air humidity levels, the evaporation, rate at the additional heat exchanger decreases drastically and, at relative air humidity levels of 100%, that is to say, in the case of warm rainy or misty weather, it is even impossible to have any evaporation cooling and consequently any energy saving. A similar effect occurs in the case of particularly dry ambient air, for example. In desert climates. The content of gaseous water in the ambient air is then so low that no condensation or only a very small amount of condensation can occur at the first heat exchanger being operated as an evaporator. Consequently, no water or only small quantities of water is/are available and the desired evaporation cooling cannot be produced, or cannot he produced sufficiently, under those environmental conditions.

### OBJECT

Consequently, an object of the invention is to provide a motor vehicle having art air-conditioning system for heating and/or cooling the passenger inner space, which allows a more energy-efficient operation of the air-conditioning system, in particular also under unfavorable environmental conditions.

### SUMMARY OF THE INVENTION

The object is achieved according to the invention in that there is provided a motor vehicle having a passenger inner space and an engine compartment, wherein the passenger inner space is separated from the engine compartment by a front wall, having an air-conditioning system which is for heating and/or cooling the passenger inner space and which comprises a compressor, an expansion valve, a first heat exchanger and at least a second heat exchanger which are connected to each other in fluidic terms by means of a heat exchange medium, further comprising a first guiding structure in order to guide a first air flow from an outer bodywork opening into the first heat exchanger which is suitable for constituting an energy exchange between the heat exchange medium, and the first air flow, wherein the first heat exchanger is connected, to the passenger inner space in order to supply the first air flow to the passenger inner space, characterized in that there is provided for a second air flow a second guiding structure which is suitable for guiding air from the passenger inner space into the second heat exchanger which is suitable for constituting an energy exchange between the heat exchange medium and the second air flow.

This motor vehicle according to the invention is based on the recognition that the air which is in the passenger inner space is valuable in terms of energy in each operating mode, that is to say, in the heating mode and cooling mode and in any temperature and humidity state of the ambient air if consideration is given to the case in which a cooling of the passenger inner space is carried out, the air which flows into the passenger inner space through the first guiding structure is powerfully pre-cooled by the first heat exchanger which is operated as an evaporator and in this instance is also dehumidified where applicable before the air flows into the passenger inner space. During the dehumidification, there is produced condensation water which can be re---used in energy terms. The dehumidified used air which is located in the passenger inner space and, which has a substantially lower temperature than the ambient air can according to the invention be used in energy terms in order to further cool the heat exchange medium of the air-conditioning system. The term. “used air” is intended, according to the invention to be understood to mean air which has an increased pollution gas proportion as a result of interaction with the vehicle occupants. The term “pollution gases” intended to refer both to, for example, odor substances, in particular from the exhalations of the passengers, and to, for example, gaseous carbon dioxide or gaseous water. Such pollution gases limit or prevent the possibility of carrying out air recirculation operation. Therefore, the motor vehicle must always be operated at a high air exchange rate in order to prevent negative effects of the pollution gases on the vehicle occupants. According to the invention the energy content of this used air is utilized. It has been found that the dominant, factor which determines the necessary air exchange rate is the carbon dioxide content from the inhaled air of the vehicle occupants. Consequently, the used air remains at a low temperature level, as a result of the high necessary exchange rate because of the gaseous carbon dioxide, if it already has to be removed again from the passenger inner space after a short time after being introduced into the passenger inner space. This air can now be guided into the second heat exchanger of the air-conditioning system of the motor vehicle according to the invention by means of the second guiding structure so that an energy exchange with the heat exchange medium of the air-conditioning system is possible. In the described case of the desired passenger inner space cooling, the second heat exchanger has the same function as the condenser of an air-conditioning system of the prior art. The motor vehicle according to the invention consequently provides an effective additional cooling so that the heat exchange medium then already arrives in a colder state at a component of the air-conditioning system of the motor vehicle according to the invention, which component is located downstream in fluidic terms. That component may be, for example, an expansion valve or an inner heat exchanger which is optionally provided in the air-conditioning system.

The motor vehicle according to the invention can also be operated more advantageously in energy terms in the event that the air of the passenger inner space is intended to he heated. In this operating state, the first heat exchanger is operated as a heating heat exchanger which heats the air before it is introduced into the passenger inner space to a desired temperature. The used warm air can now be directed by means of the second guiding structure into the second heat exchanger which acts as an evaporator in this operating state. The air available for the energy exchange has a particularly high temperature, that is to say, at least almost the temperature of the passenger inner space. Consequently, the second heat exchanger which acts as an evaporator is operated particularly effectively and can evaporate the heat exchange medium effectively, consequently the air-conditioning system operated as a heat pump heating unit also operates in a particularly efficient manner.

Consequently, it has been found that the used air of the passenger inner space always has energy terms, independently of the operation of the air-conditioning system of the motor vehicle according to the invention, that is to say, in heating or cooling mode, precisely the state which is necessary in order to ensure an improvement of the energy exchange at the second heat exchanger and consequently an energy-efficient operation of the air-conditioning system.

The second heat exchanger is preferably arranged according to the prior art in the front region of the motor vehicle where it is subjected to flow by the ambient air, for example, as a result of travel wind. However, there may also be provided an air conveying means which also allows an energy exchange between the ambient air and the heat exchange medium when the vehicle is stopped. The effect according to the invention of efficiency improvement is also produced when the second guiding structure is constructed in such a manner that the second air flow mixes with the ambient air before the air flow flows into the second heat exchanger.

According to a development of the invention, there is provision for the second guiding structure to be suitable for guiding the second air flow upstream or a partial region of a second heat exchanger which is preferably located downstream in fluidic terms inside the heat exchanger. According to this embodiment, the production of mixed air comprising ambient air and the second air flow is prevented, which can further increase the efficiency of the arrangement. Consequently, the heat exchange fluid is first temperature-controlled in a preliminary manner by the incoming ambient air and then subsequently temperature-controlled by the second air flow. It is thereby ensured that the second air flow can be used particularly efficiently. That is particularly the case when the ambient air flows past the second heat exchanger at a particularly high flow speed. If the second air flow is guided only upstream of a partial region of the second heat exchanger, however, it is possible to bring about different flow speeds and consequently to ensure a good exploitation of the energy content of the second air flow.

In the case of the motor vehicle according to the invention, various switching valves and/or heat exchangers can be provided in the fluidic cycle of the air-conditioning system if the air-conditioning system is intended to allow alternating operation, that is to say, the air-conditioning system is intended to be operated in the cooling and heating mode. As a result, different heat exchangers can then be selected and operated depending on the operating conditions desired. The second guiding structure is then preferably also suitable for conveying the second air flow into the respective heat exchanger, in which the effect according to the invention occurs or can be produced at its most energy-efficient.

The air--conditioning system of the motor vehicle according to the invention preferably has at least one additional second heat exchanger, wherein the second guiding structure is suitable for guiding air from the passenger inner space into at least one additional second heat exchanger. That additional second heat exchanger is provided for a heat exchange which is in the same direction as the second heat exchanger. This means that, in the case of operation in which a passenger inner space cooling is carried out, the heat exchange medium is also cooled in the additional second heat exchanger by the second air flow, in the case of heating it is also heated by the second air flow. That additional second heat exchanger can now be adapted in geometric and fluidic terms to the desired relationships in a particularly effective manner. For example, the heat exchanger can be configured in such a manner that a particularly efficient energy exchange can already be brought about with comparatively small air volume flows. Typical air volume flows which are supplied from the outer side to the passenger inner space and which consequently have to be removed again from the passenger inner space are from 1 to 10 m³/min, of air in a normal passenger car. However, air volume flows of from 1 to 3 m³/min, are preferably supplied to the passenger inner space and discharged from the passenger inner space again. In the case of large-volume vehicles, for example, in the case of a bus for conveying passengers, the air volume flows naturally have to be adapted to the relationships, such as, for example, the number of vehicle occupants. Ambient air supply quantities of from 0.5 to 1 m³/min, and per person have been found to be generally advantageous for motor vehicles.

If the air-conditioning system has at least one additional second heat exchanger, the second guiding structure is preferably constructed in such a manner that the second air flow car be guided into the additional second heat exchanger(s), respectively. The second guiding structure is preferably constructed in such a manner that the second air flow is guided into the additional second heat exchanger (s), with which a cooling or heating of the heat exchange medium is intended to be produced or with which this can be configured in an optimum manner. To this end, depending on the connection of the air-conditioning system for both modes, that is to say, during heating or cooling, it may be necessary for the second guiding structure to be provided with means for supplying the second air flow to the desired additional second heat exchanger(s).

There is preferably provision for the additional second heat exchanger to have smaller dimensions than the second heat exchanger. It is then ensured that the second heat exchanger, if it is operated with a very high ambient air flow, for example, with travel wind, functions very efficiently and the additional second heat exchanger can be optimally adapted to the smaller second air flow. The construction of the air-conditioning system is further simplified.

According to a development of the invention, there is provision for the additional second heat exchanger to be arranged adjacent to the front wail of the motor vehicle. The term “adjacent to the front wall” is intended to be understood to mean that the additional second heat exchanger is arranged at a suitable location between the engine of the motor vehicle and the front wall in the engine compartment. Such an arrangement has the advantage that the second guiding structure can be comparatively small. This in turn affords the advantage that an undesirable heat exchange from air from the engine compartment to the second air flow can substantially be prevented. The air inlet of the second guiding structure is then preferably arranged in the front wall or in the passenger inner space, wherein the location of the air inlet can be selected in accordance with the circumstances of the vehicle. For example, the air inlet may start behind the first or second row of passengers which may allow good air distribution of the first air flow in the passenger inner space. The second air flow which is guided in the second guiding structure is then guided through the front wall of the motor vehicle.

According to a development of the invention, there Is provision for the additional second heat exchanger to be arranged inside the passenger inner space, in particular inside an instrument trim of the motor vehicle. This arrangement prevents a front wall opening from having to be provided for the second air guiding structure. Only lines which guide the heat exchange medium have to be directed through the front wall. Since the heat exchange medium, as already described, is operated under very high pressure, those lines can be configured to be a great; deal smaller geometrically than air guiding structures. The additional second heat exchanger can be arranged behind the instrument trim, whereby a good optical covering of the structures, that is to say, the at least one additional second heat exchanger and the lines mentioned, becomes possible. However, there may also be provision for arranging the additional second heat exchanger in the rear of the passenger inner space or in the trunk compartment. Subsequently, the second guiding structure can be constructed in a particularly simple manner and it is possible to convey away the air backward out of the motor vehicle after passing the additional second heat exchanger, wherein the outer aerodynamic pressure relationships can be used in such a manner that the air is drawn out of the passenger inner space by reduced pressure after passing the additional second heat exchanger. Consequently, this arrangement allows a particularly simple provision of the second air flow.

According to a development of the invention, there is provision for the first guiding structure to be suitable for separating drop-like and/or gush-like water out of the first air flow and for separating the separated water from the first guiding structure and in particular from the motor vehicle. Since the first guiding structure is provided to guide the first air flow from an outer bodywork opening into the passenger inner space, it is particularly advantageous to construct the first guiding structure in such a manner that the water mixed with the first air flow can be reliably separated during travel in rain or during operation in a washing installation before it comes into contact with the first heat exchanger. Drop-like water is thereby prevented from accumulating on the first heat exchanger and from having its temperature changed together with the air of the first air flow, which would lead to a worsening of the energy situation. A water box having an air inlet, a separation structure, an cutlet for separated water and an air outlet is arranged inside the first guiding structure in order to separate gush-like water and drop-like water from the first air flow.

According to a development of the invention, there is provision for the first guiding structure and the second guiding structure to be arranged and constructed relative to each other so that an energy exchange is possible between the first air flow and second air flow. The advantage of such an arrangement may be explained by means of the operating state which is intended to allow cooling of the passenger inner space in the case of strong sunshine. The first guiding structure is suitable for guiding ambient air through the outer bodywork opening. In this instance the first guiding structure and the outer bodywork opening are preferably arranged in the region of the transition of the windshield to the engine hood in this case, the ambient air is heated substantially by the sunshine during the passage through the first guiding structure. Heating actions of the ambient air of up to 15° C. were measured, which considerably worsens the energy efficiency of the air-conditioning systems of motor vehicles in cooling mode. In particular, this heating effect is pronounced when a water box which is efficient with respect to the water separation performance and consequently large and which has a large surface and a small flow resistance is provided at the engine compartment side adjacent to the front wall. If the first and second guiding structures are constructed so that an energy exchange is possible between the first and second air flows, in this operating state the further heated first air flow can discharge heat to the second air flow. The first air flow is thereby pre-cooled. The first and second guiding structures are consequently constructed in this development of the invention at least partially as low-pressure, air/air heat exchangers. The term “low-pressure, air/air heat exchanger” is intended to be understood to mean that both gases are approximately at normal pressure of one bar. Small pressure deviations from the normal pressure may result from the operation of any air conveying means which produce the first and/or second air flow. In the other heat exchangers mentioned in the publication, the heat exchange medium is, as already described, always under high pressure of several bar even if the medium is gaseous or super-critical at the heat exchanger (s). Pressures of up to over 100 bar can even be produced. According to experience, it is unnecessary to construct the efficiency of this low-pressure, air/air heat exchanger to be particularly high so that the second air flow can still guide energy by means of the second guiding structure into the second heat exchanger and/or into at least one additional second heat exchanger, where applicable. Naturally, it is particularly advantageous to construct the water box, which is incorporated in the guiding structure where applicable, at least predominantly, more preferably at least substantially, as a low-pressure, air/air heat exchanger. Such an arrangement ensures that less or even no unfavorable heating of the ambient air takes place and at the same time the residual energy of the second air flow is still available for cooling the heat exchange medium in the second heat exchanger and/or in at least one additional second heat exchanger where applicable. Such arrangements are consequently quite particularly energy-efficient. A substance exchange between the first and the second air guiding structure should be substantially prevented in this case since such leaks can make the energy balance worse.

According to a development of the invention, there is provision for the first guiding structure and/or second guiding structure to be provided at least in the engine compartment with a thermal insulation in the direction toward the ambient air and/or the engine compartment air. This configuration ensures that the first and/or second air flow change(s) in terms of energy in a negative manner to the smallest possible extent during the path through the respective guiding structure. Any negative changes reduce the efficiency of the air-conditioning system of the motor vehicle according to the invention, which can be at least reduced or substantially prevented by the provision of a suitable thermal insulation. This development of the invention is consequently particularly energy-efficient.

According to a development of the invention, there is provision for the motor vehicle to he provided with means for filling and storing a water supply and further with means which make it possible to convey stored water into the second guiding structure and, where applicable, to atomize and/or evaporate it there. A water atomizer may be, for example, an ultrasound atomizer. That atomizer produces a particularly fine-drop-like mist which again results in high and effective evaporation actions. This arrangement leads to a particularly energy efficient operation of the air--conditioning system if the passenger inner space is intended to be cooled. The decisive aspect in this case is that the first air flow is not only cooled before introduction into the passenger inner space but also dehumidified in accordance with the ambient conditions. The first heat exchanger is in principle operated in such a manner that a comparatively dry air is always available in the passenger inner space, which corresponds to the general perception of comfort of vehicle occupants and prevents any misting of windows. After the air of the passenger inner space has been used, the air is supplied to the second guiding structure, where water from the water supply can further be evaporated and/or atomized. An additional intensive evaporation cooling of the second air flow is thereby produced, in particular because the air to be humidified is comparatively dry. Consequently, not only is the energy state of the air of the passenger inner space used, but also at the same time the energy expenditure of the drying action of the first air flow is recuperated. That drying energy recuperation is also successful under particularly unfavorable environmental conditions, for example, when the ambient air is saturated with gaseous water, which occurs in, the event of rain or mist the evaporation cooling can also be used when the motor vehicle operated in desert climates with little or no occurrence of condensation water because the water supply can be constructed to be able to be refilled from the outer side.

There is further preferably provision for the first heat exchanger to be provided with means for collecting any condensation water and for supplying the condensation water to the means for storing a water supply. This allows the re-use of the condensation water occurring at the first heat exchanger so that the storage container does not have to be re-filled or has to be re-filled less often from the outer side, or can be constructed to be smaller.

According to a development of the invention, there is provision for carbon dioxide to be provided as the heat exchange medium. The heat exchange medium is operated in the trans-critical mode particularly during summer operation for which a cooling of: the passenger inner space is provided, which makes it harder to have efficient back-cooling at the second heat exchanger. According to the invention, however, the efficiency of the second heat exchanger and/or the at least one additional second heat exchanger, where present, is substantially increased so that: the air-conditioning system can also still be operated safely and with a high level of cooling power under particularly unfavorable environmental conditions, that is to say, very high ambient temperatures of, for example, 40° C. or more

According to a development of the invention, there is provision for the air-conditioning system not to contain an inner heat exchanger. Iii general, the inner heat exchanger ensures subsequent temperature-control of the air-conditioning system in air-conditioning systems of the prior art if in particular the second heat exchanger cannot provide adequate energy efficiency in accordance with the heat exchange medium used. The inner heat exchanger partially allows only the operation or an air-conditioning system of the prior art, in particular in trans-critical mode. As a result of the insertion of an inner heat exchanger, however, as already described, the energy efficiency decreases. If, however, the energy efficiency of the second heat exchanger is increased according to the invention, according to this development the inner heat exchanger may be dispensed with in the air-conditioning system of the motor vehicle according to the invention, which allows a simplified construction of the air-conditioning system. The disadvantage of the poorer energy efficiency is further avoided.

According to a development of the invention, there is provision for an air conveying means to he provided inside the second guiding structure. This arrangement affords its advantages in particular when a partial air recirculation operation is provided for the vehicle air-conditioning. The term. “air recirculation operation” is intended to he understood to mean that the used passenger air is drawn in again and supplied to the first guiding structure at a suitable location so that the used air again passes the first heat exchanger. The used air can consequently be temperature-controlled and where applicable subsequently dehumidified by means of the first heat exchanger, in particular any gaseous humidity which results, for example, from the exhalations of the vehicle passengers, can be removed by means of the first heat exchanger from the used air with formation of condensation water. However, a disadvantage with exclusive air recirculation operation is that the proportion of gaseous carbon dioxide in the passenger inner space immediately increases greatly, which contradicts safe operation of the motor vehicle by the vehicle driver already at comparatively low concentrations of carbon dioxide in the passenger inner space. Therefore, it may be advantageous to provide a simultaneous partial ambient air operation and air recirculation operation. According to the invention, the ambient air proportion of the first air flow can now be safely controlled by the controlled operation of the second air conveying means in the second guiding structure. If particularly precise partial air recirculation operation is desired, there may be provided a first air conveying means in the first guiding structure which constitutes the conveying of the air recirculation portion. As a result of the independently controlled operation of the two air conveying means, a simultaneous very precise ambient air and recirculation air proportion in the first air flow which flows into the passenger inner space can be adjusted without air recirculation valves necessarily having to be actuated inside the first guiding structure. This development of the invention further ensures that the air which is conveyed into the second guiding structure is reliably supplied to the second heat exchanger and/or at least one additional second heat exchanger, where present, even if increased flow resistances cannot be avoided in the second guiding structure, depending on the geometric situation in the motor vehicle.

### FIGURES

Other advantageous features will be appreciated from the descriptions of preferred embodiments of the invention which are set cut in the following figures and from the dependent claims. The figures, the embodiments and the claims contain a number of features partially in combination. However, the person skilled in the art will advantageously also consider the features individually and/or combine them to form additional combinations which achieve the set objective in a particular manner.

FIG. 1 describes a motor vehicle according to the invention having an air-conditioning system,

FIG. 2 describes another embodiment according to the invention,

FIG. 3 describes an embodiment according to the invention of a second guiding structure,

FIG. 4 describes another embodiment according to the invention of a second guiding structure,

FIG. 5 describes an embodiment according to the invention using water which can be evaporated.

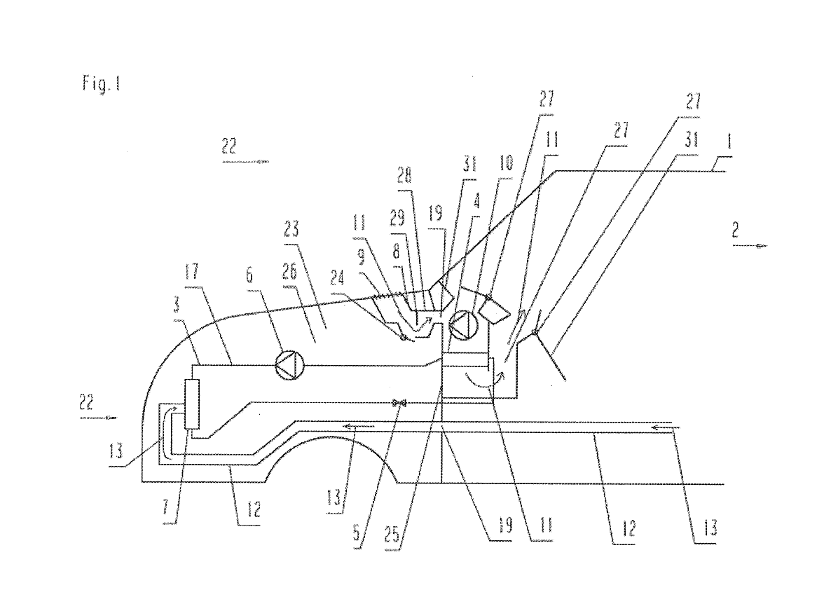

FIG. 1 schematically illustrates the front portion of a motor vehicle 1 which has a passenger inner space 2 and which is surrounded by the ambient air 22. There is further illustrated the air-conditioning system. 3 having a compressor 6, an expansion valve 5, a first heat exchanger and a second heat exchanger 7. These components are connected together by means of a fluidic connection 17. The air-conditioning system 3 is constructed in a hermetically tight manner and filled with a heat exchange medium under high pressure of from 3 to 150 bar. The compressor 6 of this embodiment can be operated in two directions. If it produces in relation to the figure a flow of the heat exchange medium in a counter-clockwise direction, the air-conditioning system 3 is operated in the cooling mode; if the heat exchange medium is operated in the clockwise direction, the air-conditioning system 3 is operated in the heating mode.

The first heat exchanger 4 is arranged in the first guiding structure 8. The guiding structure 8 is suitable for supplying a first air flow 11 from an outer bodywork opening 9 through the front wall 25 with the front wall opening 19 into the passenger inner space 2. Consequently, the first heat exchanger 4 is suitable for controlling the temperature of the passenger inner space 2, that is to say, to cool in cooling mode and to heat in heating mode. The first guiding structure 8 can be constructed in such a manner that additional components can he arranged at the passenger space side of the front wall opening 19. Thus, a first air conveying means 10 and an air filter for cleaning the ambient air 22 supplied can be arranged. It is further possible to provide additional components which can also be used to control the temperature of the passenger inner space 2. If those additional components are combined in a compact module, the person skilled in the art refers to it as an air-conditioning module which can then be arranged inside an instrument trim 31. In any case, the air-conditioning module is a portion of the first guiding structure 8. The components air filter 16 and first air conveying means 10 are optionally provided. Thus, for example, there may be provision for the first air flow 11 to be produced by the travel movement of the motor vehicle 1. This can be ensured with suitable positioning of the outer bodywork opening 9. Depending on the desired operation of the air-conditioning unit 3, it is then possible to dispense with a first air conveying means 10 for producing the first air flow 11. The first guiding structure 8 may have one or more optionally closable openings 27, by means of which air can be supplied again from the passenger inner space 2 to the first guiding structure 8. This air can then be directed at least via the first heat exchanger 4 again. This device is then suitable for air recirculation operation. The first guiding structure 8 can be further guided downstream of the first heat exchanger 4 so that the first air flow can be supplied to a desired location inside the passenger inner space 2. In this instance, the first guiding structure 8 may also be branched and may be provided with additional closure elements, which is not illustrated here.

The first guiding structure 8 of this embodiment is constructed as a water box 28 at the engine compartment side of the front wall 25. The first guiding structure has in the engine compartment 26 a thickened portion, within which a separation element 29 is arranged. Such constructions allow an efficient and reliable separation of liquid or solid water which is added to the ambient air 22. A closable water outlet 24 must then he provided.

There is further illustrated the second guiding structure which is illustrated in a tubular manner here. The tubular construction may be provided so as to have a round or rectangular geometry but it is possible per se to select any shapes which can be adapted to the geometric requirements of the motor vehicle I. It begins in the passenger inner space 2, extends through the front wail 25 and opens directly upstream of the second heat exchanger 7 When viewed in the travel direction. There may also be provision for the second guiding structure 12 to be connected directly to the second heat exchanger 7. There may also be provision for the second guiding structure 12 to he further guided downstream of the air flow of the second heat exchanger in order to supply the second air flow 13 advantageously at a suitable location to the ambient air 22. Consequently, the second guiding structure 12 is suitable for guiding air from the passenger inner space 2 into the second heat exchanger 7. In this instance, the energy exchange according to the invention between the heat exchange medium and the second air flow can be illustrated. In the cooling mode, the heat exchange medium is further cooled by the second air flow 13, which improves the energy efficiency of the air-conditioning system 3. In this example, the second heat exchanger 7 is arranged directly at the vehicle front adjacent to the radiator grill. Consequently, an energy exchange between the ambient air 22 and the heat exchange medium may also be constituted in the second heat exchanger 7. The ambient air 22 and the second air flow 13 can also be supplied as mixed air. In order to convey the ambient air 22 into the second neat exchanger 7, the movement of the motor vehicle 1 can be used, which is referred to as travel wind. It is also possible to provide an air conveying means for conveying ambient air 22 into the second heat exchanger 7, which is not illustrated here.

In this embodiment, a first air conveying means 10 is provided in the first guiding structure 8 in order to produce the first air flow 11. The second guiding structure 12 ensures that the air is conveyed away out of the passenger inner space 2 by means of the second air flow 13 so that a significant excess pressure cannot be produced in the motor vehicle 1. Consequently, it is not absolutely necessary that a second air conveying means 20 be provided in the second guiding structure 12. Consequently, the second air flow 13 is ensured by the pressure relationships in the passenger inner space 2. If a periodic air recirculation operation is provided, for example, by actuation of one or more closable openings 27, there is produced within the passenger inner space 2 an air flow which does not comprise any air supply of ambient air 22 and consequently also does not produce a second air flow 13. As soon as ambient air 22 is conveyed into the passenger inner space 2 via the outer bodywork opening 9, however, the second air flow 13 in the second guiding structure 12 is also produced at the same time.

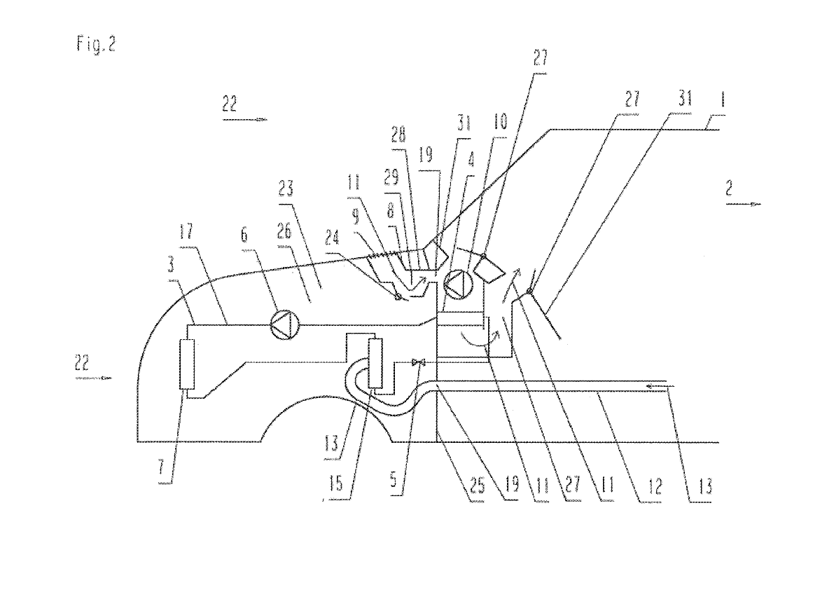

FIG. 2 describes a very similar construction. The difference here is that an additional second heat exchanger 15 is provided. The second heat exchanger 7 is arranged as in FIG. 1 near the vehicle front and the additional second heat exchanger 15 is illustrated adjacent to the front wall 25 in this instance. The term “adjacent” is intended to mean here that it is arranged between a propulsion unit (not illustrated here) and the front wall 25 in the engine compartment 26. The second guiding structure 12 now guides the second air flow 13 in that additional second heat exchanger 15, where an energy exchange according to the invention between the heat exchange medium and the second air flow 13 can be constituted. Consequently, the second guiding structure 12 can be constructed to be geometrically shorter and consequently simpler. Furthermore, a negative energy exchange between the ambient air 22 and the engine compartment air 23 can be reduced. The additional second heat exchanger 15 can also be adapted to the second air flow 13 in an optimum manner so that a highly efficient energy exchange is possible. In particular, the additional second heat exchanger 15 can be constructed to be smaller than the second heat exchanger 7. This is particularly advantageous if the second air flow 13 is constructed to be smaller than, for example, the travel wind which strikes the second heat exchanger 7. It is also possible to arrange the additional second heat exchanger 15 inside the second guiding structure 12. Such an arrangement prevents any losses if a portion of the second air flow 13 would otherwise flow around the additional second heat exchanger so that a reduced energy exchange between the second air flow 13 and the heat exchange medium would occur.

Furthermore, a possible embodiment is constructed in such a manner that the second guiding structure 12 is also guided, in addition to the guiding into the additional second heat exchanger 15 via a branch which is not illustrated here, into the second heat exchanger 7. This branch can be connected, for example, via movable redirection elements. Such embodiments may be particularly advantageous when air-conditioning systems 3 are provided so as to have a plurality of first and/or second heat exchangers 4, 7. According to the prior art, the heat exchangers are then often connected in such a manner that the heat exchangers 4, 7 take up an exchange function in a mode, for example, heating mode. Put not in the other mode, for example, cooling mode. For example, there may be provided in the fluidic cycle of the heat exchange medium four heat exchangers 4, 7 which are each operated only in one mode. The arrangement of such perferably switchable branches may then be advantageous in order to guide the second air flow 13 in each mode upstream of the second heat exchanger 7, 15 which is most suitable in terms of energy.

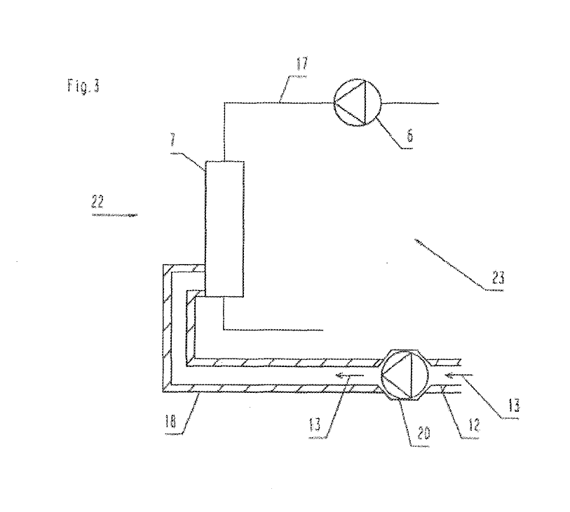

FIG. 3 describes a cut-out from FIG. 1 or FIG. 2. There is illustrated a second heat exchanger 7, to which ambient air 22 is supplied, for example, by the travel wind or an air conveying means, which is not illustrated here, in the upper region. It is indicated that, in this embodiment, the compressor 6 produces a flow of the heat exchange medium in a counter-clockwise direction. In the upper region of the second heat exchanger, an energy exchange between the ambient air 22 and the heat exchange medium may be produced. The second guiding structure 12 is arranged in a region of the second heat exchanger 7 n located downstream in fluidic terms with respect to the heat exchange medium. The guiding structure 12 is suitable for guiding the second air flow 13 into the second heat exchanger 7 in such a manner that an energy exchange with the heat exchange medium can be produced. This arrangement has the advantage that the second heat exchanger 7 can be adjusted in an optimum manner to the flow of the ambient air 22 or the second air flow 13 in reuions. Nevertheless, the arrangement of only a second heat exchanger 7 is sufficient here, which allows a simple construction.

The second guiding structure 12 of this embodiment has a thermal insulation 18 with respect to the ambient air 22 or the engine compartment air 23. Such embodiments prevent or reduce a negative energy exchange with the ambient air 22 or with the engine compartment air 23.

A second air conveying means 20, which can control the second air flow 13 in a particularly precise manner, is also arranged in the second guiding structure 12 in this embodiment. If a first air conveying means 10 is also arranged in the first guiding structure 8, that first air conveying means 10 can produce, for example, a flow of recirculation air by means of the actuation of the closable openings 27, whilst the second air conveying means 20 in the second guiding structure 12 not only produces the second air flow 13 but also conveys the first air flow 12, the ambient air 22 into the passenger inner space 2 by means of the pressure relationships in the passenger inner space being kept constant. Consequently, such a construction is particularly well-suited for providing a continuous, precisely controlled, simultaneous first air flow 11 and second air flow 13, on the one hand, and a flow of recirculation air produced independently. As a result, a constantly high air quality with a high level of energy efficiency of the air-conditioning system 3 of the motor vehicle 1 can be produced with the overall arrangement of this embodiment, for example, in accordance with the number of, occupants in the passenger inner space or in accordance with the concentration of gaseous carbon dioxide.

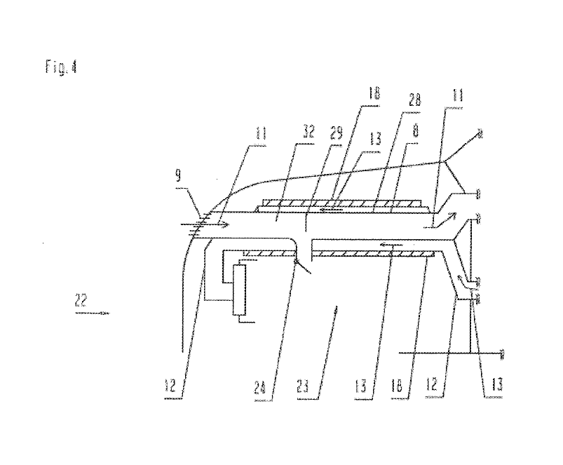

FIG. 4 is a cut-out of another embodiment. The first guiding structure 8 has the outer bodywork opening 9 in the front region of the vehicle, wherein an elongate water box 28 is integrated in the first guiding structure 8. A closable water outlet 24 and a separation element 29 are also indicated inside the water box 28. There is further provided a second guiding structure 13 which begins in the passenger inner space 2 and which closely extends round the first guiding structure 8, whereby a low-pressure air/air heat exchanger 32 is formed. This means that a portion of the energy which is contained in the second air flow 13 can be transmitted to the first air flow 11. The first air flow 11 is pre-cooled in the cooling mode and it is pre-heated in the heating mode. At the same time, the system prevents or reduces a situation in which the first air flow 11 is further heated in the cooling mode, for example, in the case of powerful sunshine or a high level of heat being discharged from the engine. The second air flow 13 is guided according to the invention into the second heat exchanger 7 after leaving the low-pressure air/air heat exchanger 32, where an energy exchange with the heat exchange medium can take place according to the invention.

Furthermore, the second guiding structure 12 of this embodiment is provided with a thermal insulation 18 which prevents or reduces an undesirable energy transfer to the second air flow 13 as a result of sunshine or interaction with the ambient air 22 and/or engine compartment air 23.

Such an arrangement is particularly advantageous because the energy of the air to be separated from the passenger inner space 2 can be used particularly effectively in terms of energy and, at the same time, negative environmental influences are prevented. Consequently, the first air flow is protected from negative influences both by the thermal insulation 18 and by the second air flow

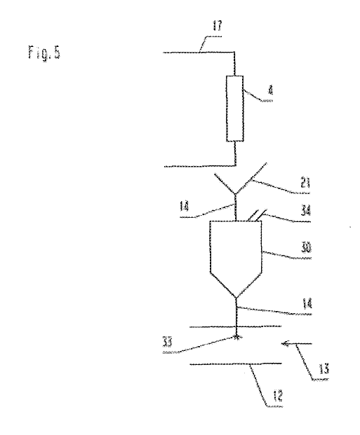

FIG. 5 describes as a cut-out how the second air flow 13 can be further cooled in the cooling mode by water which can be evaporated being supplied thereto.

There is illustrated the or a first heat exchanger 4 with the fluidic connection 17, which at the same time has means for collecting condensation water 21. Condensation water may occur on the first heat exchanger 4 in the cooling mode. A storage container for water 30 is also provided. It can take up any condensation water via a line for water 14, but can also he filled with water from the outer side by means of a filling device 34.

A line for water 14 extends from the storage container for water 30 to a water atomizer 33 which is arranged in the second guiding structure 12 and which is suitable for atomizing or nebulizing water. An ultrasound atomizer may be provided as the water atomizer 33 but other embodiments are possible which may allow evaporation of water in the second guiding structure 12. This may be, for example, a spray device. That atomized, nebulized or sprayed water can now be supplied to the second air flow 13 where it evaporates and thus results in an additional cooling of the second air flow 13. That evaporation coldness can now also be transmitted to the first air flow 11 via the low-pressure air/air heat exchanger 32 but the energy contained in the second air flow 13 is also available alternatively or additionally for an energy transfer to the heat exchange medium of a second heat exchanger 7, 15. Such embodiments are particularly efficient from the point of view of energy. Furthermore, in the embodiment having a storage container 30, 34 which can be filled from the outer side, it is particularly advantageous that the condensation coldness can also be used for an energy transfer when no or no adequate quantities of water at the first heat exchanger 4 can be removed from the first air flow 11 in the case of very dry ambient air 22, for example, in desert climates.

### LIST OF REFERENCE NUMERALS

1 Motor vehicle

2 Passenger inner space

3 Air-conditioning system

4 First heat exchanger

5 Expansion valve

6 Compressor

7 Second heat exchanger

8 First guiding structure

9 Outer bodywork opening

10 First air conveying means

11 First air flow

12 Second guiding structure

13 Second air flow

14 mine for water

15 Additional second heat exchanger

16

17 Fluidic connection

18 Thermal insulation

19 Front wall opening

20 Second air conveying means

21 Means for collecting condensation water

22 Ambient air

23 Engine compartment air

24 Closable water outlet

25 Front wall

26 Engine compartment

27 Closable opening

28 Water box

29 Separation element

30 Storage container for water

31 Instrument trim

32 Low-pressure air/air heat exchanger

33 Water atomizer

34 Filling device

1. A motor vehicle having
a passenger inner pace,
an engine compartment,
a front wall that separates the passenger inner space from the engine compartment and
an air-conditioning system which is for heating and/or cooling the passenger inner space and which comprises a compressor, an expansion valve, a first heat exchanger and at least one second heat exchanger, which are connected to each other in fluidic terms by means of a heat exchange medium, further comprising a first guiding structure in order to guide a first air flow from an outer bodywork opening into the first heat exchanger which is suitable for constituting an energy exchange between the heat exchange medium and the first air flow,
wherein the first heat exchanger is connected to the passenger inner space in order to supply the first air flow to the passenger inner space,
wherein
there is provided for guiding a second air flow a second guiding structure which is suitable for guiding air from the passenger inner space into the second heat exchanger,
and wherein the second heat exchanger is suitable for constituting an energy exchange between the heat exchange medium and the second air flow.

2. The motor vehicle as claimed in claim 1, wherein the second guiding structure is suitable for guiding the second air flow upstream of a partial region of a second heat exchanger which is preferably located downstream in fluidic terms inside the second heat exchanger with respect to the ambient air flow.

3. The motor vehicle as claimed in claim 1, wherein at least one additional second heat exchanger is provided, wherein the second guiding structure is suitable for guiding air from the passenger inner space into at least one additional second heat exchanger.

4. The motor vehicle as claimed in claim 3, wherein the at least one additional second heat exchanger has smaller dimensions than the second heat exchanger.

5. The motor vehicle as claimed in claim 3, wherein the at least one additional second heat exchanger is arranged adjacent to the front wall.

6. The motor vehicle as claimed in claim 3, wherein the at least one additional second heat exchanger is arranged inside the passenger inner space, in particular inside an instrument trim of the motor vehicle.

7. The motor vehicle as claimed in claim 1 wherein the first guiding structure is suitable for separating drop-like and/or gush-like water out of the first air flow and for removing the separated water from the first guiding structure and in particular from the motor vehicle.

8. The motor vehicle as claimed in claim 1 wherein the first guiding structure and the second guiding structure are arranged and constructed relative to each other so that an energy exchange is possible between the first air flow and second air flow.

9. The motor vehicle as claimed in claim 8, wherein a water box, which is incorporated in the first guiding structure, is constructed at least predominantly, preferably substantially, as a low-pressure, air/air heat exchanger.

10. The motor vehicle as claimed in claim 1 wherein the first guiding structure and/or second guiding structure is/are provided at least in the engine compartment with a thermal insulation in the direction toward the ambient air and/or the engine compartment air.

11. The motor vehicle as claimed in claim 1 wherein it is provided with arrangements for filling and storing a water supply and further with a device which makes it possible to convey stored water into the second guiding structure and, where applicable, to atomize and/or evaporate it there.

12. The motor vehicle as claimed in claim 11, wherein the first heat exchanger is provided with a device for collecting any condensation water and for supplying the condensation water to the arrangement for storing a water supply.

13. The motor vehicle as claimed in claim 1 wherein carbon dioxide is provided as the heat exchange medium.

14. The motor vehicle as claimed in claim 1 wherein the air-conditioning system does not contain an inner heat exchanger.

15. The motor vehicle as claimed in claim 1 wherein a second air conveying device is provided inside the second guiding structure.
